(19) United States
(12) Patent Application Publication
(10) Pub. No.: US 2012/0215716 A1
(43) Pub. Date: Aug. 23, 2012

(54) Financial Instrument Transferable from an Employer to an Employee

(75) Inventors: Robert Charles Shier, JR., Irvine, CA (US); Andrew Jacob Shourds, Irvine, CA (US); Michael Robert Shute, Newport Beach, CA (US)

(73) Assignee: The Prudential Insurance Company of America, Newark, NJ (US)

(21) Appl. No.: 13/032,415

(22) Filed: Feb. 22, 2011

(51) Int. Cl. G06Q 40/00

(52) U.S. Cl. 705/36 R; 705/35

(57) ABSTRACT

According to one embodiment, a method for administering a financial instrument includes storing a balance of an employee retirement plan account created for an employee and owned by an employer of the employee. The employee retirement plan account includes one or more variable investments. The balance of the employee retirement plan account is based, at least in part, on an initial deposit into the employee retirement plan account from a deduction from wages paid by the employer to the employee. The method also includes storing a minimum positive growth rate. The method further includes updating the stored balance of the employee retirement plan account based on market performance of the one or more variable investments. The method further includes calculating a protected value, and, upon occurrence of one or more events, transferring ownership of the employee retirement plan account from the employer to the employee.

### TECHNICAL FIELD

This invention relates generally to financial instruments and more particularly to a financial instrument transferable from an employer to an employee.

### BACKGROUND

There are numerous financial instruments available on the market and people invest in them for a variety of reasons. Some investors are interested in obtaining high rates of return on their investments, while others are willing to forego high rates of return in exchange for a reduced level of financial risk. Some investors are interested in obtaining a steady income stream for a period of years or possibly for life. When making decisions regarding the selection of a financial instrument, there are multiple tradeoffs. Typically, the lower the risk is, the lower the expected rate of return will be.

In addition to risk and return, there are numerous tax consequences that may be considered in selecting a financial instrument. For example, tax-deferred investments are typically preferred. Tax-deferred investments are investments that satisfy one or more regulatory requirements that allow for contributions to the investment with pre-tax dollars and/or that allow the investment to grow tax-free for a period of time. Tax-deferred investments may be included within, for example, 401(a), 401(k), 403(b), and 457 employee retirement plans, qualified or non-qualified annuities, and individual retirement accounts (IRAs). Some typical employee retirement plans and IRAs allow investors to choose among a variety of investments and to move funds between these chosen investments.

An annuity is one form of financial instrument. A typical annuity is used to pay a certain sum of money at specified intervals, with the payment amount being based on a given amount of principal. There are many different types of annuities. For example, annuities can be immediate or deferred, fixed or variable, and single payment or multiple payment.

In a typical immediate annuity, a lump sum of money is exchanged for a stream of payments to begin immediately. In a typical deferred annuity, an investment is made with the anticipation that it will grow and a stream of payments based upon the value of the account at a future time will begin at some point in the future. A fixed annuity is one in which the rate of return is specified at the time the annuity is purchased. A variable annuity typically allows the purchaser to select from a group of potential investments and the rate of return depends upon the performance of the selected investments.

In some cases, annuities provide additional benefits such as death benefits, cash surrender benefits, or joint and survivor income payment options. Typically, however, annuities may not be offered by an employer (such as a corporation or a corporate sponsored trust) to an employee as an option for retirement.

### SUMMARY

According to one embodiment, a method for administering a financial instrument includes storing a balance of an employee retirement plan account created for an employee and owned by an employer of the employee. The employee retirement plan account includes one or more variable investments. The balance of the employee retirement plan account is based, at least in part, on an initial deposit into the employee retirement plan account from a deduction from wages paid by the employer to the employee. The method also includes storing a minimum positive growth rate. The method further includes updating the stored balance of the employee retirement plan account based on market performance of the one or more variable investments. The method further includes calculating, by one or more processor devices executing logic, a protected value. The calculated protected value is at least equal to the initial deposit into the employee retirement plan account growing at the stored minimum positive growth rate, wherein the calculated protected value represents a guaranteed positive rate of return regardless of market performance of the one or more investments. The method further includes upon occurrence of one or more events, transferring ownership of the employee retirement plan account from the employer to the employee, wherein subsequent to or simultaneous to the transfer of ownership, a beneficiary designated by the employee is guaranteed to receive the beneficiary's choice of either: a lump sum of money from the employee retirement plan account based on the updated stored balance of the employee retirement plan account, or for the life of the employee or the beneficiary, periodic payments of an amount of money from the employee retirement plan account based on the calculated protected value regardless of the market performance of the one or more investments.

Certain embodiments may provide various technical advantages. For example, based on the transfer of ownership of the financial instrument from the employer to the employee, certain embodiments may allow the employer (such as a corporation or a corporate sponsored trust) to offer an annuity to the employee as a retirement plan without incurring one or more of the disadvantages typically associated with such an offering.

Certain embodiments may further allow an employee to fund an annuity as a retirement plan using pre-tax dollars. Certain embodiments may further allow an employee to fund an annuity as a retirement plan using pre-tax dollars even though the employee has already maxed out other tax-deferred retirement plan options, such as an IRA. Certain embodiments may further allow an employee to select one or more variable investments while the financial instrument is owned by the employer, and if the market performance of the selected investments do not meet a predetermined threshold, certain embodiments may further allow these selected investments to be replaced by investments that may be safer.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and various advantages, reference is now made to the following description, taken in conjunction with the accompanying drawings, in which:

FIG. 1 illustrates a system for providing a financial instrument according to a particular embodiment;

FIG. 2 illustrates a financial instrument according to a particular embodiment;

FIG. 3 illustrates an example transfer of ownership of a financial instrument according to a particular embodiment;

FIG. 4 illustrates an example of a calculation of a protected value based on a market value of a financial instrument according to a particular embodiment;

FIG. 5 provides a flowchart illustrating the operation of a financial instrument according to a particular embodiment;

FIGS. 6A and 6B illustrate an example data processing system for providing a financial instrument according to a particular embodiment; and

FIG. 7 illustrates an embodiment of a general purpose computer.

### DETAILED DESCRIPTION OF THE EXAMPLE EMBODIMENTS

It should be understood at the outset that although example implementations of embodiments of the invention are illustrated below, the present invention may be implemented using any number of techniques, whether currently known or not. The invention should in no way be limited to the example implementations, drawings, and techniques illustrated below. Additionally, the drawings are not necessarily drawn to scale.

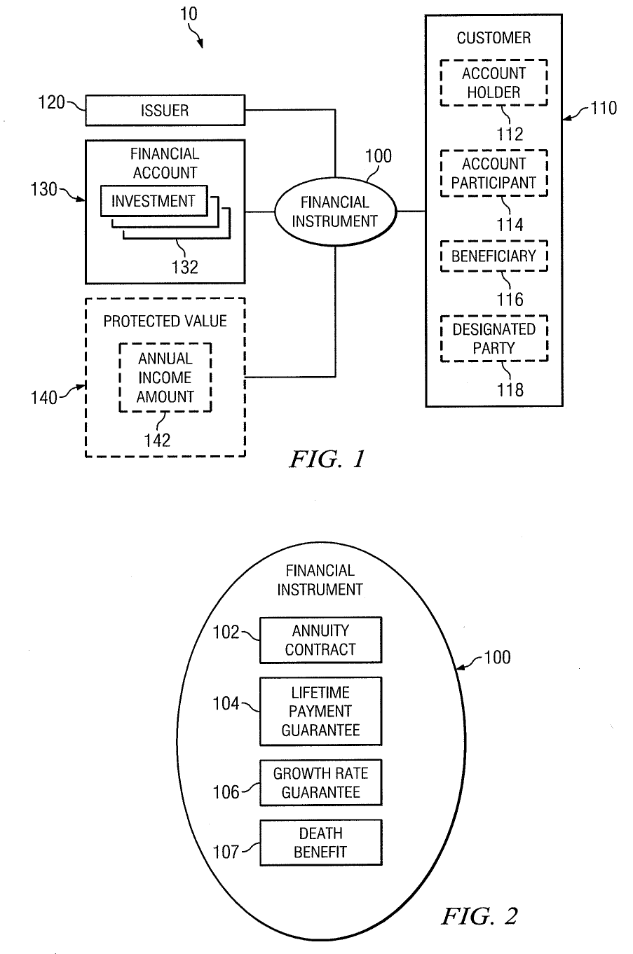

FIG. 1 illustrates a system 10 for providing financial instrument 100 according to a particular embodiment. System 10 may interact with customer 110 and issuer 120; and system 10 may utilize account 130 and protected value 140. Financial instrument 100 may represent a contract between customer 110 and issuer 120. Financial instrument 100 may include certain provisions as described below in relation to FIG. 2.

According to certain embodiments, system 10 may be utilized to provide financial instrument 100 to customer 110, such that customer 110 may make a deposit and retain liquidity, while also receiving the benefit of a guarantee of lifetime payments and/or the security associated with a guaranteed growth rate.

Customer 110 may broadly refer to one or more of an account holder 112, an account participant 114, a beneficiary 116, a designated party 118, and/or one who purchases financial instrument 100 for another person or entity. In certain embodiments, account holder 112 may represent a party who purchases financial instrument 100 and/or who is attributed as being an owner of account 130. For example, account holder 112 may be a corporation that purchases a financial instrument 100 for an employee using money deducted from the employee's wages. In such an example, the corporation (e.g., account holder 112) owns the financial instrument until the corporation transfers the financial instrument 100 to the employee (e.g., account participant 114). In certain embodiments, account participant 114 may have one or more rights in account 130. For example, account participant 114 may have the right to terminate financial instrument 100, to make investment decisions for account 130, to identify one or more beneficiaries 116, to identify one or more designated parties 118, to decide when deposits should be made into account 130, and/or to decide how much money should be deposited into the account 130. In a particular embodiment, account holder 112, account participant 114, or both account holder 112 and account participant 114 may be the entities who have tax liability for the transactions related to account 130. For example, while account holder 112 owns financial instrument 100, account holder 112 may have tax liability for changes in the value of account 130. As another example, upon occurrence of a transfer of ownership of financial instrument 100 from account holder 112 to account participant 114, account participant 114 may have to pay taxes on all or a portion of the value of financial instrument 100. In a further embodiment, upon the transfer of ownership of financial instrument 100 from account holder 112 to account participant 114, account holder 112 may also have tax consequences as a result of the transfer of ownership of financial instrument 100.

In certain embodiments, beneficiary 116 may represent a party who may receive payments and/or make withdrawals in accordance with the terms of financial instrument 100. In certain embodiments, designated party 118 may represent an individual, group of individuals, and/or other entity that may be designated for purposes of determining death benefits, lifetime payments, fees, guaranteed rates, and/or other features of financial instrument 100. For example, guaranteed rates and/or fees may be determined based upon the age, gender, and/or health of designated party 118. As another example, death benefit provisions may be based upon the death of designated party 118.

In certain embodiments, financial instrument 100 may be purchased by account holder 112 for account participant 114, for the benefit of beneficiary 116, with designated party 118 being the designated life for the guarantee of lifetime payments. In certain embodiments, one or more of account participant 114, beneficiary 116, and designated party 118 may be the same party. For example, account holder 112 may be an employer and an employee may be account participant 114, beneficiary 116, and designated party 118.

In certain embodiments, one or more of account participant 114, beneficiary 116, and designated party 118 may be related. For example, designated party 118 and beneficiary 116 may be related as husband and wife. Alternatively, account participant 114 and beneficiary 116 may be the same individual or entity. In some embodiments, an employer might purchase account 130 for account participant 114. Also, financial instrument 100 may have multiple beneficiaries 116, and/or designated parties 118. For example, a husband and a wife may both be beneficiaries 116 and designated parties 118. As another example, two or more business partners could be designated parties 118. While this patent describes various actions, benefits, steps, etc. in relation to a customer 110, account holder 112, account participant 114, beneficiary 116, and/or designated party 118, those descriptions should not be construed as limiting because financial instrument 100 might provide for various persons to exercise control, take various actions, receive certain benefits, and/or affect certain features with regard to financial instrument 100.

Issuer 120 may represent an entity that provides and/or sells financial instrument 100 to customer 110. Issuer 120 may represent a bank, an insurance company, mutual fund company, or other business entity engaged in the sale of one or more financial instruments. Issuer 120 may also represent multiple entities that operate together to provide or sell financial instrument 100.

Account 130 may represent a principal balance including amounts deposited by customer 110 (and/or transferred from a separate account) together with accrued growth due to a return on one or more investments. The value of account 130 may be distributed among one or more investments 132. Investment 132 may provide a fixed or variable return, and the value of account 130 may be distributed among any combination of investments 132, such as municipal bonds, bond funds, money market accounts, corporate securities, index funds, mutual funds, real estate investment trusts, or any other appropriate type of investments. In certain embodiments, account 130 may include one or more investments 132 associated with multiple financial entities. In certain embodiments, the value of account 130 may be withdrawn in whole or in part at the discretion of customer 110. In various embodiments, issuer 120 may restrict the investments 132 available to customer 110 or allow customer 110 to accept certain limitations in exchange for other benefits. Account 130 may or may not be associated with issuer 120. In some embodiments, a third party administering account 130 may contract with issuer 120 to provide the guarantees. An insurance company, for example, might provide the guarantees for mutual fund accounts administered by a third party or for other types of financial accounts.

In certain embodiments, where appropriate regulatory requirements are met, account 130 may represent a tax-deferred account. In embodiments where account 130 represents a tax-deferred account, customer 110 may make one or more deposits into account 130 using pre-tax funds and/or account 130 may be permitted to grow tax-free for a period of time. As used herein, the term “tax” may refer to one or more taxes levied by a federal, state, and/or any other appropriate taxing authority.

Protected value 140 represents a value all or a portion of which issuer 120 guarantees that beneficiary 116 will be able to receive. Protected value 140 may be based upon the value of account 130 at some point in time. In some embodiments, although account 130 may decrease due to market fluctuations, protected value 140 does not, thus providing a guaranteed rate of return regardless of market performance. In certain embodiments, protected value 140 may be based upon a deposit and the deposit may include an account balance from an existing contract. Thus, in some embodiments, the guarantees described herein may be added to existing financial instruments after the passage of time.

In certain embodiments, the amount and/or the guaranteed percentage of protected value 140 may vary based on certain characteristics of customer 110. For example, the guaranteed percentage of protected value 140 (or protected value 140 itself) may vary based upon the gender, age, and/or health status of one or more of account participant 114, beneficiary 116, and designated party 118. In certain embodiments, the amount and/or the guaranteed percentage of protected value 140 may vary depending upon whether and to what extent customer 110 accepts certain limitations on flexibility and/or control over account 130 and/or distributions therefrom. In certain embodiments, the amount and/or the guaranteed percentage of protected value 140 may vary depending on the timing of one or more events.

In certain embodiments, protected value 140 may be calculated at the time that financial instrument 100 is purchased, and in other embodiments protected value 140 may be calculated at the end of a certain period of time, upon the happening of a triggering event, or on a periodic basis. In some embodiments, protected value 140 may be based upon a combination of factors and calculated at different times. Depending upon the embodiment, protected value 140 may become fixed at some point in time. In certain embodiments, protected value 140 may become fixed at the time that one or more deposits are made into account 130. In certain embodiments, protected value 140 may become fixed upon an election by customer 110.

Numerous methods may be used to fix protected value 140 at some point in time. For example, protected value 140 may be calculated as equal to the value of account 130 at the time of the transfer of the ownership of the financial instrument from the account holder 112 to the account participant 114. Alternatively, protected value 140 may be calculated as the highest value of account 130 at one or more specified times or at any time. For example, protected value 140 may be calculated as the highest value of account 130 on each of the first ten anniversary dates, where the anniversary date may be an anniversary of the purchase date of financial instrument 100, a birthday of customer 110, a wedding date for customer 110, or a date specified by customer 110. In embodiments where a calculation is based on an anniversary date, when the anniversary date falls on a weekend, holiday, or other non-business day, the calculation may be based on the immediately preceding business day (or, alternatively, on the next business day).

In embodiments in which the calculation of protected value 140 (or any other feature of financial instrument 100) is based on a birthday of customer 110, a wedding date for customer 110, or a date specified by customer 110, financial instrument 100 may advantageously provide enhanced customization by customer 110 and may reduce the number of critical dates that customer 110 may need to consider. In addition, through the use of one of these dates, issuer 120 may diversify the risk and reduce any seasonal overhead cost associated with issuing numerous financial instruments 100, all having identical issuing dates (as may occur if a critical date is associated with a calendar year, a fiscal year, or the initiation of a group plan for a large number of employees on the same date).

In certain embodiments, protected value may be calculated as the greater of multiple calculation methods. For example, protected value 140 may be calculated as the value of account 130 on the date of the transfer of ownership from the account holder 112 to the account participant 114, or the highest value of account 130 on the first ten anniversary dates, but in no event less than the initial value of account 130 growing at a five percent growth rate for the first ten years. As another example, protected value 140 may be calculated as the value of account 130 on the date of the transfer of ownership from account holder 112 to account participant 114, or the highest value of account 130 on each anniversary of the birthday of account participant 114 between the date that financial instrument 100 was purchased and the date of the transfer of ownership from the account holder 112 to the account participant 114, but in no event less than the initial value of account 130 growing at a five percent growth rate until the earliest of the business day prior to the first withdrawal from the account 130, such as a withdrawal after ownership of the financial instrument has been transferred to the account participant, or the date that account participant 114 turns seventy. As an additional example, the protected value 140 may be calculated each time the value of account 130 increases to a new high, but in no event less than the greater of the initial value of account 30 growing at a five percent growth rate until the financial instrument is transferred to account participant 114, or the previous protected value 140 amount growing at a five percent growth rate until the financial instrument is transferred to account participant 114. In such an example, account participant 114 receives the benefit of an increasing market value of investments, and further receives the benefit of previous protected value 140 amounts. In certain embodiments, the growth rate utilized in these examples may alternatively be three percent, four percent, six-percent, or based on an index.

In certain embodiments, protected value 140 may be calculated based upon the value of account 130 prior to the inclusion of any bonuses. Alternatively, in certain embodiments, protected value 140 may be calculated based upon the value of account value 130 with additional bonuses (or other incentives) added. For example, issuer 120 may pay a bonus to entice customers to purchase the guarantees discussed herein. Various embodiments may include any method of determining protected value 140.

In certain embodiments, the amount and/or the guaranteed percentage of protected value 140 may change after it has been initially determined. As one example, the amount and/or guaranteed percentage of protected value 140 may change based upon changes in the law. As another example, the amount and/or guaranteed percentage of protected value 140 may change based upon an inflationary index, interest rate, or exchange rate. As yet another example, the amount and/or guaranteed percentage of protected value 140 may change based upon changes in the health or age of customer 110.

In certain embodiments, customer 110 may be allowed to step-up protected value 140 at specified times or at any time. For example, following an election to step-up protected value 140, protected value 140 may be set as equal to the current value of account 130. In a particular embodiment, customer 110 may elect to step-up protected value 140 at any time after the fifth anniversary of the first withdrawal, with additional step-ups being available five years after the date of the previous step-up election. A step-up in protected value 140 may require further deposits to account 130.

In certain embodiments, protected value 140 may be automatically stepped-up on a periodic basis or upon the happening of particular events. For example, an automatic step-up of protected value 140 may occur on a monthly, quarterly, or yearly basis. In a particular embodiment, a step-up to protected value 140 may automatically occur on an annual basis after the first withdrawal, with protected value 140 being set as equal to the greatest of the value of financial account 130 on the previous quarterly anniversaries if that amount is greater than the current protected value 140. In alternative embodiments, monthly, bi-monthly, semi-annual, or any other appropriate anniversary may be used and automatic step-ups may occur on a semi-annual, quarterly, monthly, or any other appropriate basis.

In certain embodiments, customer 110 may be allowed to step-up protected value 140 or protected value 140 may be automatically stepped-up on an annual basis associated with an anniversary date. In certain embodiments, the anniversary date may be an anniversary of the purchase date of financial instrument 100, a birthday of customer 110, a wedding date for customer 110, or a date specified by customer 110. In these embodiments, when the anniversary falls on a weekend, holiday, or other non-business day, protected value 140 may be stepped-up on the immediately preceding business day (or, alternatively, on the next business day).

In certain embodiments, rather than setting protected value 140 as equal to the value of account 130 on a certain anniversary, protected value 140 may be set as a percentage of such a value, as a certain value appreciated at a specified growth rate, or as any other appropriate value. In certain embodiments, the step-up value for protected value 140 may take into consideration any additional purchase payments and adjustments to these purchase payments.

In certain embodiments, financial instrument 100 may include one or more provisions that protect the guarantor of protected value 140 from risky investment behavior. For example, since protected value 140 provides a guarantee of the value that financial instrument 100 has to account participant 114, beneficiaries 116, and designated parties 118, an account participant 114 may be tempted to invest in overly risky investments based on the idea that if the investments increase in value, account participant 114 receives a benefit, and if the investments fail, account participant 114 is protected by protected value 140. As such, in particular embodiments, financial instrument 100 may provide one or more provisions that reduce such risky behavior. For example, when financial instrument 100 is first created, account participant 114 may provide a selection of the investments 132 in account 130. In such an embodiment, account 130 may continue to include the selections provided by account participant 114 as long as the value of the selected investments does not decrease below a predetermined threshold. However, if the value of the selected investments decreases below the predetermined threshold, the provisions of financial instrument 100 may allow account participant 114's investment selections to be replaced by investments 132 that may be less risky. For example, if the market value of a particular investment 132 selected by account participant 114 decreases below a predetermined threshold, the particular investment may be removed from account 130 and replaced by an investment 132 that may be less risky. In one embodiment, this replacement investment 132 may be selected by issuer 120, a guarantor of protected value 140, or an entity working on the behalf of issuer 120 or the guarantor. In such an embodiment, issuer 120 may be able to substitute account participant 114's investment selections with investments 132 that may be considered to be safer.

In one embodiment, the predetermined threshold that may trigger such a replacement may refer to a number, percentage, indicator, or any other suitable threshold. For example, the predetermine threshold may refer to a particular market value of the investment (e.g., such as a value of $5,000), a particular percentage of the investment (e.g., such as five percent), an expected performance of the investment (e.g., such as a growth rate of two percent), and/or a performance of one or more market indicators (e.g., such as the performance of the Dow Jones Industrial Average). In certain embodiments, if the account participant 114's selected investment decreases below such a threshold, the selected investment may be replaced.

In certain embodiments, certain provisions of financial instrument 100 may be managed through the use of annual income amount 142. For example, a guarantee of lifetime payments may be managed by calculating annual income amount 142 and evaluating discretionary withdrawals in relation to annual income amount 142. For example, if the cumulative withdrawals for a certain year exceed annual income amount 142, then annual income amount 142 may be reduced accordingly for future years.

In the operation of certain embodiments, customer 110 may purchase financial instrument 100 from issuer 120 (or an agent thereof). In some cases, the purchase may occur electronically. Issuer 120 may then create account 130 and associate one or more deposits made by customer 110 with account 130. In certain embodiments, customer 110 may make investment choices regarding the allocation of funds associated with account 130. Protected value 140 may be calculated using one or more specified calculation methods.

In some embodiments, following the purchase of financial instrument 100, customer 110 may make additional deposits to and/or discretionary withdrawals from account 130. Withdrawals from account 130 may or may not be required or allowed based upon the terms of financial instrument 100. The timing of withdrawals may or may not be regulated by financial instrument 100. For example, withdrawals by customer 110 may only be allowed after ownership of financial instrument 100 has been transferred from account holder 112 to account participant 114. In certain embodiments, withdrawals can be taken as separate partial withdrawals or as systematic withdrawals. For example, withdrawals may be automated and may be set up on a periodic basis, with the period being yearly, quarterly, monthly, etc.

Although financial instrument 100 has been described as being purchased directly from issuer 120 in certain embodiments, financial instrument 100 may be purchased through one or more intermediaries.

FIG. 2 illustrates a particular embodiment of financial instrument 100. In the embodiment shown, financial instrument 100 includes annuity contract 102, lifetime payment guarantee 104, growth rate guarantee 106, and death benefit 107. Annuity contract 102 may represent a contract for a broad range of annuity products. For example, annuity contract 102 may represent a deferred variable annuity such as ANNUITY ONE 3 issued by PRUCO LIFE INSURANCE COMPANY. In certain embodiments, annuity contract 102 may represent a contract between customer 110 and issuer 120, wherein customer 110 may make deposits and/or withdrawals during an accrual phase and then issuer 120 may make payments during a distribution phase. The transition from the accrual phase to the distribution phase may occur following an election by customer 110 to annuitize account 130.

In addition to the basic terms of annuity contract 102, financial instrument 100 may include additional provisions including lifetime payment guarantee 104, growth rate guarantee 106, and death benefit 107. Although annuity contract 102, lifetime payment guarantee 104, growth rate guarantee 106, and death benefit 107 are shown as separate elements, one or more of these elements may be combined, and each of these elements may also include numerous components.

In certain embodiments, different elements of financial instrument 100 may be purchased or elected at different times. For example, annuity contract 102 may be purchased in year one, and lifetime payment guarantee 104 and growth rate guarantee 106 may be purchased or elected in year one or at anytime thereafter. In certain embodiments, the scope or provisions of one or more of lifetime payment guarantee 104, growth rate guarantee 106, and death benefit 107 may be modified after the purchase of annuity contract 102. For example, annuity contract 102 may be purchased with lifetime payment guarantee 104, such that issuer 120 guarantees that beneficiary 116 will receive payments for the life of designated party 118, with designated party 118 and beneficiary 116 being the same individual. Then, according to this example, at a later date, an election may be made to expand the scope of lifetime payment guarantee 104, such that issuer 120 guarantees that beneficiary 116 will receive payments for the life of designated party 114, with designated party 118 and beneficiary 116 being both the individual and the spouse of the individual.

In certain embodiments, lifetime payment guarantee 104 may include provisions guaranteeing that beneficiary 116 may receive financial transfers for life, beginning at or after a specified triggering event. For example, in certain embodiments, these financial transfers may be due to discretionary withdrawals and/or payments. In certain embodiments, the amount of (and/or a limit for) these financial transfers may be fixed or variable. For example, the amount of (and/or a limit for) these financial transfers may be determined based upon the age, gender, health status, and/or other morbidity factors for one or more individuals. As another example, the amount of (and/or a limit for) these financial transfers may be independent of such factors. In certain embodiments, the amount of (and/or the limit for) these financial transfers may change after a period of time according to a set schedule, changes in an external index, and/or any appropriate factor.

In certain embodiments, the amount of (and/or a limit for) these financial transfers may be determined based upon specified percentages of protected value 140. For example, the amount of (and/or a limit for) these financial transfers may be set at a first percentage for a certain period and then change to second percentage for another period. In certain embodiments, these percentages may be fixed upon the effective date of lifetime payment guarantee 104, upon the date of a first financial transfer, or upon any other appropriate date. In certain embodiments, the amount of (and/or a limit for) these financial transfers may vary based on the age of customer 110 on the date of a first financial transfer.

For example, in a particular embodiment, the amount of (and/or a limit for) these financial transfers may be a first percentage of protected value 140 per year when the date of the first financial transfer is prior to the date customer 110 turns a threshold age and may be a second percentage of protected value 140 per year when the date of the first financial transfer is on or after the date that customer 110 turns the threshold age. In a particular embodiment, the threshold age may be sixty-five, the first percentage may be four percent, and the second percentage may be five percent, although any percentage and any threshold may be used. In an alternative embodiment, multiple threshold ages may be establish to distinguish between three or more amounts of (and/or limits for) these financial transfers.

In certain embodiments, lifetime payment guarantee 104 may guarantee that beneficiary 116 will receive no less than annual income amount 142 each year for the life of designated party 118, beginning with an event. In certain embodiments, annual income amount 142 may be four percent, five percent, or six percent of protected value 140, but any percentage of any measured amount could be used. In certain embodiments, each measuring year for annual income amount 142 may be determined based on an anniversary date, where the anniversary date may be an anniversary of the purchase date of financial instrument 100, a birthday of customer 110, a wedding date for customer 110, or a date specified by customer 110. In certain embodiments, protected value 140 may be adjusted upwards or downwards based on certain events. For example, protected value 140 may be increased by additional deposits and may be decreased by cumulative withdrawals in a single year that exceed annual income amount 142.

In certain embodiments, growth rate guarantee 106 may include provisions allowing customer 110 to make withdrawals from account 130 based upon deposits made by customer 110. The provisions may further provide that the withdrawals may be made from a value that is guaranteed to grow at a specified fixed or variable rate for a specified period of time. For example, growth rate guarantee 106 may allow beneficiary 116 to make withdrawals from protected value 140, with protected value 140 guaranteed to be no less than the value of customer deposits growing at a fixed five percent per year for ten years from the date of the first deposit or until the date of the first withdrawal, whichever is sooner.

In certain embodiments, the specified rate for growth rate guarantee 106 may be any positive fixed value. In certain embodiments, the specified rate for growth rate guarantee 106 may be zero or a fixed negative value. In embodiments where the specified rate is zero or a fixed negative value, the beneficial aspects of growth rate guarantee 106 may include a reduction in risk for customer 110. In certain embodiments, the specified rate may be based on one or more variable indices. For example, the specified rate may be based on the Consumer Price Index, a stock market index, and/or the Federal Reserve's discount rate.

In certain embodiments, the specified rate may vary depending on the timing of deposits, the size of deposits, and/or the value of investments 132. For example, different rates may apply to different deposits or the overall rate may be calculated based on the rates in effect at the time that deposits are made, weighted based on the relative size (or actual size) of the deposits. In certain embodiments, the specified rate may vary based on characteristics of account holder 112, beneficiary 116, and/or designated party 118. For example, the specified rate may vary depending on the gender, age, or health status of designated party 118.

In certain embodiments, the guaranteed growth may be set at a first rate for a specified period of time, or until a specified event occurs, and then change to a second rate. For example, the guaranteed growth rate may be zero for the first two years and then may change to a fixed five percent growth rate for the next eight years. In certain embodiments, the growth rate may change numerous times, with the changes occurring based upon specified periods of time and/or upon the occurrence of specified events.

In embodiments of financial instrument 100 including death benefit 107, death benefit 107 may include provisions allowing for payments to be made to a recipient designated by account participant 114 and/or beneficiary 116, upon the death of designated party 118. For example, payments made under death benefit 107 may be made to beneficiary 116 upon the death of designated party 118, where designated party 118 is account participant 114. As another example, payments made under death benefit 107 may be made to an identified third party beneficiary upon the death of designated party 118 or beneficiary 116. Death benefit 107 may provide for payment of an amount based upon the value of account 130, protected value 140, or some other value identified in death benefit 107. For example, death benefit 107 may provide for payment in the amount of the value of account 130 at the time of death. As another example, death benefit 107 may provide for payment in the amount of the highest value of account 130 on any anniversary of the effective date of financial instrument 100. In certain embodiments, death benefit 107 may provide for payment in the amount of the highest of multiple calculation methods. Although death benefit 107 has been illustrated and described as a separate element of financial instrument 100, death benefit 107 may be formed from multiple components and/or may be included as part of another element of financial instrument 100.

In certain embodiments, financial instrument 100 may provide for an option allowing customer 110 to elect to receive the present value of future guaranteed payments. For example, in embodiments where the charge for lifetime payment guarantee 104 is an up-front charge, financial instrument 100 may allow for customer 110 to cancel lifetime payment guarantee 104 and receive a payment (or credit to account 130) calculated based upon the present value of the guarantee. In these embodiments, the calculation may or may not include an underwriting assessment of the life expectancy of customer 110. Furthermore, such an option may only be available subsequent to or simultaneous to the ownership transfer of financial instrument 100 from account holder 112 to account participant 114.

As indicated above, in certain embodiments, financial instrument 100 may provide for multiple beneficiaries 116 and financial instrument 100 may provide for various persons to exercise control. For example, financial instrument 100 may provide that both a husband and a wife are beneficiaries 116 and designated parties 118. Financial instrument 100 may further provide that, after the ownership of the financial instrument has transferred from account holder 112 to account participant 114, the husband may make discretionary withdrawals from account 130 and, if the husband pre-deceases the wife, that the wife may make discretionary withdrawals from account 130 after the husband's death. Additionally, financial instrument 100 may further provide that if account value 130 reaches zero during the husband's life, then the husband may receive periodic payments for life and then, upon his death, the wife may receive periodic payments for her life. In certain embodiments, financial instrument 100 may include similar provisions for business partners or other arrangements involving multiple beneficiaries 116 and/or designated parties 118.

The costs associated with each element of financial instrument 100 may be assessed together or as separate charges, and the charges may be assessed in different ways. For example, the costs may be assessed as up-front charges, as asset charges, or as charges against withdrawals or payments. In certain embodiments, the costs may be charged periodically and/or may vary over time. For example, there may be no charge for a period of time and/or the charge may increase or decrease over time depending on a variety of factors. In certain embodiments, the costs may be charged in a manner such that the charge is assessed pro-rata over multiple investments or accounts 130, according to an election by customer 110, and/or such that the tax consequences of the charge are substantially minimized. In a particular embodiment, the charge for each element is assessed as a daily asset charge against the value of account 130. For example, the charge assessed for lifetime payment guarantee 104 and growth rate guarantee 106 may be an eighty-five basis point charge (0.85 percent per year) assessed against the daily balance of account 130. In embodiments in which both a husband and a wife are beneficiaries 116 and designated parties 118, the charge assessed for lifetime payment guarantee 104 and growth rate guarantee 106 may be a 135 basis point charge (1.35 percent per year) assessed against the daily balance of account 130. In certain embodiments, financial instrument 100 may allow customer 100 to purchase financial instrument 100 and then defer the decision as to whether to include both husband and wife as beneficiaries 116 and/or designated parties 118 until a later date. In a particular embodiment, financial instrument 100 may allow customer 110 to wait until the time of a first withdrawal from account 130 to decide whether to include both a husband and a wife as beneficiaries 116 and designated parties 118. In these particular embodiments, the charge assessed for lifetime payment guarantee 104 and growth rate guarantee 106 may be an eighty-five basis point charge (0.85 percent per year) assessed against the daily balance of account 130 during the accrual phase and a 135 basis point charge (1.35 percent per year) assessed against the daily balance of account 130 during the distribution phase. As yet another example, the charge assessed for death benefit 107 may be a 140 basis point charge (1.40 percent per year) assessed against the daily balance of account 130.

In certain embodiments, one or more features of financial instrument 100 may be dependent upon an age of customer 110. For example, in certain embodiments, customer 110 may not be eligible to purchase and/or utilize certain features of financial instrument 100 before customer 100 attains a specified age. In a particular embodiment, customer 110 may not be eligible for one or more guarantees prior to attaining the age of fifty. In particular embodiments, where customer 110 represents multiple individuals, the age utilized to determine eligibility may be the age of the youngest individual. For example, if designated party 118 includes both a husband and a wife, then one or more guarantees may not be available until both the husband and the wife attain the age of fifty.

Although not illustrated in FIG. 2, financial instrument 100 may further include a portability guarantee and a continuation guarantee. In certain embodiments, the portability guarantee may include provisions allowing customer 110 to transfer all or a portion of account 130 to a separate financial instrument together with one or more features of financial instrument 100. For example, in certain embodiments, the portability guarantee may include provisions guaranteeing that issuer 120 will make available to customer 110 a financial instrument substantially similar to financial instrument 100 such that if customer 110 transfers all or a portion of account 130 to the separate financial instrument, then all or a portion of protected value 140 or annual income amount 142 may be retained by customer 110 under the separate financial instrument. In certain embodiments, such an option may only be available subsequent to or simultaneous to the ownership transfer of the financial instrument from account holder 112 to account participant 114.

In certain embodiments, the continuation guarantee may include provisions allowing one or more features of a separate financial instrument to be transferred to financial instrument 100 together with a financial transfer from the separate financial instrument into account 130. For example, in a particular embodiment, one or more of protected value 140 and annual income amount 142 may be set as equal to all or a portion of a substantially similar value associated with the separate financial instrument. In certain embodiments, such an option may only be available subsequent to or simultaneous to the ownership transfer of the financial instrument from account holder 112 to account participant 114.

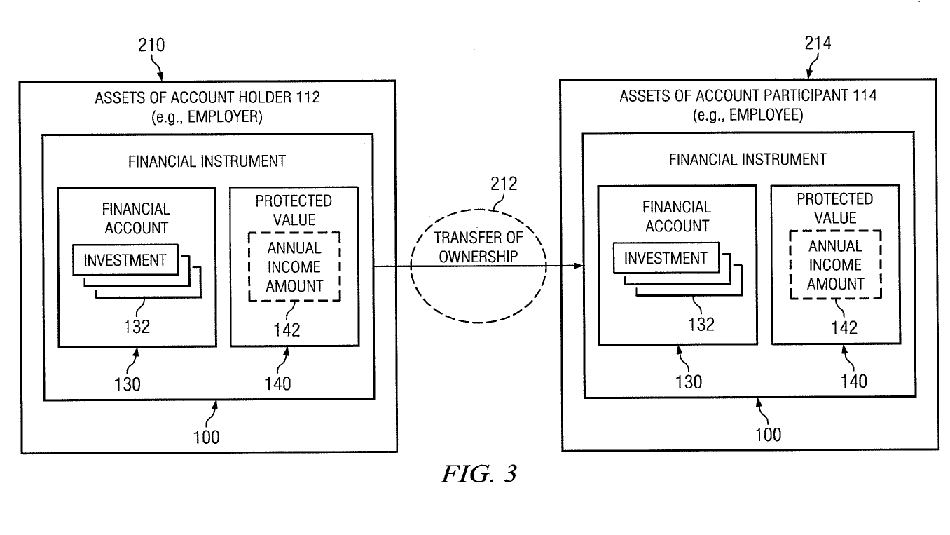

FIG. 3 illustrates an example transfer of ownership of a financial instrument according to a particular embodiment. In the embodiment shown in FIG. 3, transfer of ownership 212 of financial instrument 100 is directed from account holder 112 to account participant 114.

According to the illustrated embodiment, financial instrument 100 includes a variable annuity. In further embodiments, financial instrument 100 may include any other suitable annuity, such as immediate or deferred, fixed or variable, and single payment or multiple payment annuities. In another embodiment, financial instrument 100 may include any other suitable non-qualified deferred compensation plan.

As is illustrated in FIG. 3, the ownership of financial instrument 100 is transferred from account holder 112 to account participant 114. Account holder 112 may represent a party who purchases financial instrument 100 and/or who is attributed as being an owner of account 130. Account participant 114, on the other hand, may have one or more rights in account 130 (such as, for example, the right to terminate financial instrument 100, to make investment decisions for account 130, to identify one or more beneficiaries 116, to identify one or more designated parties 118, to decide when deposits should be made into account 130, and/or to decide how much money should be deposited into the account 130), until ownership of financial instrument 100 is transferred to account participant 114. After such an ownership transfer, account holder 112 may no longer have any ownership rights in financial instrument 100, and account participant 114 may have complete ownership and control of financial instrument 100.

According to the illustrated embodiment, account holder 112 may be an employer, and account participant 114 may be an employee of account holder 112. For example, account holder 112 may be a corporation that the employee (e.g., account participant 114) works for. In further embodiments, account holder 112 may be a corporate sponsored trust, or another entity defined as a “non-natural” entity by federal regulations. According to the illustrated embodiment, account holder 112 may be referred to as an employer, and account participant 114 may be referred to as an employee.

Prior to the transfer of ownership of financial instrument 100 from the employer to the employee, the employer must first have ownership of financial instrument 100. In particular embodiments, the employer begins ownership of financial instrument 100 when employer purchases financial instrument 100 for the employee. In one embodiment, the employer may purchase financial instrument 100 using money deducted from wages paid by the employer to the employee. In such an embodiment, the money may be pre-tax dollars. In a further embodiment, a financial instrument 100 may be purchased individually for each employee. As such, each purchase is a separate transaction. Furthermore, the purchase of financial instrument 100 may include a contract signed by both the employer and the employee.

Once the employer purchases financial instrument 100, financial instrument 100 may become part of the employer's assets 210. Thus, the employer owns financial instrument 100, and the employee may only have certain rights to financial instrument 100. For example, as is discussed above, the employee may have the right to terminate financial instrument 100, to make investment decisions for account 130, to identify one or more beneficiaries 116, to identify one or more designated parties 118, to decide when deposits should be made into account 130, and/or to decide how much money should be deposited into account 130.

After a period of time where financial instrument 100 is owned by the employer (e.g., where financial instrument 100 is included in employer's assets 210), transfer of ownership 212 of financial instrument 100 may occur. In certain embodiments, transfer of ownership 212 may by conducted by or with the help of a computer, such as, for example, general purpose computer 600 described in FIG. 7. In one embodiment, transfer of ownership 212 may be a transfer in-kind to the employee. According to the illustrated embodiment, transfer of ownership 212 may result in financial instrument 100 being transferred from the employer to the employee (e.g., resulting in financial instrument 100 being transferred from employer's assets 210 to employee's assets 214). As such, the employer may no longer have ownership of financial instrument 100, and the employee may receive ownership rights of financial instrument 100. For example, the employee (or beneficiary 116) may now be able to make withdrawals from financial account 130, choose to begin receiving lifetime payments from the annual income amount 142, or elect to receive a lump sum from account 130. In one embodiment, when the employee elects to receive a lump sum from account 130, the lump sum may be based on the value of account 130, not the value of protected value 140. As such, if the value of account 130 is less than protected value 140 (e.g., such as when the market value of investments 132 has failed to keep up with the guaranteed interest rate of protected value 140), the amount the employee receives from the lump sum may be less than protected value 140.

In particular embodiments, transfer of ownership 212 may not cause any changes to financial instrument 100. For example, as is indicated in FIG. 3, during the time when financial instrument 100 is owned by the employer (e.g., it is part of employer's assets 210), financial instrument 100 includes financial account 130, investments 132, protected value 140, and annual income amount 142. After transfer of ownership 212, financial instrument 100 may be owned by the employee (e.g., it is now part of the employee's assets 214), and financial instrument 100 may still include financial account 130, investments 132, protected value 140, and annual income amount 142. Therefore, in one embodiment, financial instrument 100 may not change as a result of transfer of ownership 212.

In further embodiments, transfer of ownership 212 of financial instrument 100 may result in changes to financial instrument 100. For example, although financial instrument 100 may still include financial account 130, investments 132, protected value 140, and annual income amount 142, the value of one or more of these elements may be different. In particular, one or more fees (and/or tax liabilities) may be associated with transfer of ownership 212. As such, the value of financial account 130 may be reduced upon occurrence of transfer of ownership 212. As another example, protected value 140 may change upon transfer of ownership 212. For example, protected value 140 may be recalculated upon transfer of ownership 212. In such an example, protected value 140 may increase or decrease based on the current market value of investments 132 at the time of transfer of ownership 212.

As indicated above, transfer of ownership 212 may occur after a period of time during which financial instrument 100 is owned by the employer (e.g., financial instrument 100 is included in employer's assets 210). In particular embodiments, transfer of ownership 212 may occur for any particular reason and after any suitable period of time. For example, transfer of ownership 212 may occur as a result of the termination of employment of the employee, retirement of the employee, restructuring of the employer, the employee's request to receive ownership of financial instrument 100, a predetermined amount of time elapsing after the creation of financial instrument 100, or any other suitable reason. In one embodiment, transfer of ownership 212 may occur without a new contract being signed between the employee and issuer 120. As such, the contract entered into when financial instrument 100 was purchased may still be valid after transfer of ownership 212.

In particular embodiments, transfer of ownership 212 may result in a tax liability for the employer, the employee, or both the employer and the employee. For example, upon occurrence of transfer of ownership 212, the employee may have to pay taxes on all or a portion of the value of financial instrument 100. In a further embodiment, upon transfer of ownership 212, the employer may also have tax consequences as a result of transfer of ownership 212 of financial instrument 100.

In particular embodiments, the transactions discussed above (e.g., such as the employer purchasing financial instrument 100, the employer owning financial instrument 100, and/or transfer of ownership 212 from the employer to the employee) may provide one or more advantages. For example, these transactions may provide advantages to the employee. In particular, the purchase of financial instrument 100 (and any subsequent deposit into account 130 of financial instrument 100) may be funded using money deducted from wages paid by the employer to the employee. As such, where appropriate regulatory requirements are met, account 130 may represent a tax deferred account, where deposits into account 130 are made using pre-tax funds and/or account 130 may be allowed to grow tax-free for a period of time. Therefore, in one embodiment, the employee may be able to fund an additional retirement account using pre-tax dollars even though the employee has maxed out other personal retirement plans, such as an IRA.

As a further example, these transactions discussed above (e.g., such as the employer purchasing financial instrument 100, the employer owning financial instrument 100, and/or transfer of ownership 212 from the employer to the employee) may also provide advantages to the employer. In particular, an employer, such as a corporation, may be able to provide additional retirement account options to their employees as further incentives to work for the employer. For example, based on the transactions discussed above in FIG. 3, the employer may be able to provide an annuity as a retirement plan for the employee funded using pre-tax dollars. Without one or more of these transactions discussed above, an annuity offered by an employer may result in various adverse conditions that would dissuade an employer from offering such an annuity. For example, typically, an employer, such as a corporation, may not receive tax savings from an annuity. Therefore, because a corporation may receive tax savings from other retirement plan options, such as a 401(k), the employer may be financially prevented from offering an annuity option to the employee. Accordingly, an annuity is traditionally not a viable option for an employer such as a corporation or a corporate sponsored trust.

These transactions discussed above, however, may allow a corporation to provide an annuity to an employee. For example, an employer such as a corporation must typically recognize annuity market value appreciation/depreciation as ordinary income/loss each year, similar to other taxable securities. Traditionally, this would have prevented the employer from providing an annuity option to an employee. However, in particular embodiments, by purchasing an annuity individually for each employee, and later transferring ownership of the annuity to the employee, an employer, such as a corporation, may not incur an asset/liability mismatch on their balance sheet—thus making an annuity offering more enticing. For example, with regard to a balance sheet for an employer, the employer may record the annuity benefit obligation as a liability on the balance sheet. This obligation may represent the “promise to pay” that the employer has made to each individual employee who participates in the annuity. After the annuity is purchased by the employer, the liability may be adjusted upward/downward based on future deferrals/contributions and market earnings/losses.

In particular embodiments, these adjustments may be hedged by the employer also recording the purchased annuity as an asset on its balance sheet. This annuity asset may be equal to the guaranteed income benefit plan liability. Under such a structure, the asset may move in lockstep with the guaranteed income liability, thus creating a hedge for income statement purposes. Accordingly, by owning each individual annuity and later transferring ownership of the annuity to the employee, the employer may avoid certain consequences that traditionally prevented an employer from providing an annuity option to an employee.

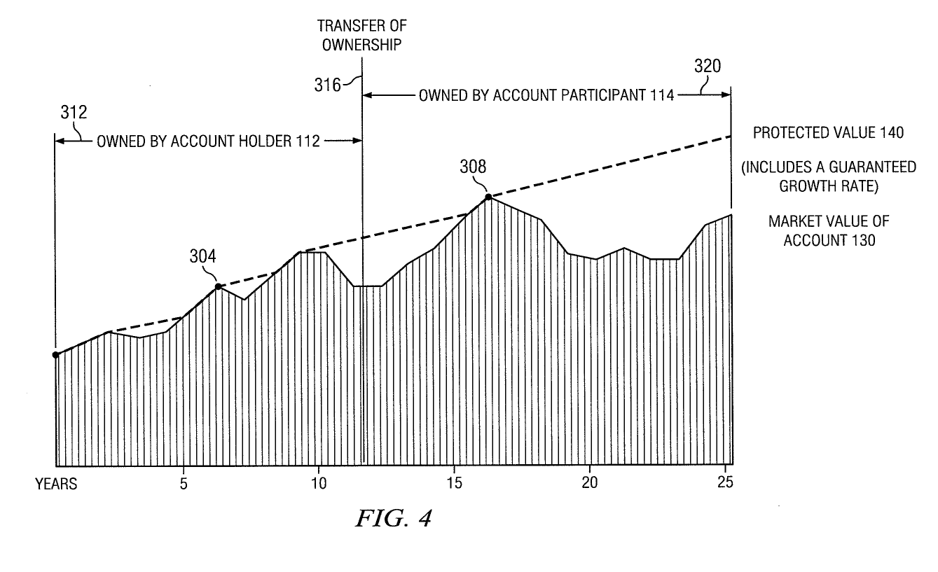

FIG. 4 illustrates an example of a calculation of a protected value based on a market value of a financial instrument according to a particular embodiment. According to the illustrated embodiment, protected value 140 may be calculated each time the value of account 130 increases to a new high, but in no event less than the greater of the initial value of account 130 growing at a five percent growth rate, or the previous protected value 140 amount growing at a five percent growth rate. The new high of account 130 may refer to a value that is higher than both the previous high of account 130 and also the value of the previous protected value 140 growing at a five percent growth rate (or the initial value of account 130 growing at a five percent growth rate). As such, account participant 114 receives the benefit of an increasing market value of investments 132, and further receives the benefit of previous protected value 140 amounts. In certain embodiments, protected value 140 may be calculated (and/or recalculated) by or with the help of a computer, such as, for example, general purpose computer 600 described in FIG. 7.

According to the illustrated embodiment, protected value 140 is recalculated as the market value of account 130 each time account 130 reaches a new high. For example, at point 304 the market value of account 130 of instrument 100 reaches a new high. As such, protected value 140 may automatically be recalculated at that new high value occurring at point 304. Therefore, in one embodiment, protected value 140 may now be this new high value (e.g., such as $100,000) growing at a five percent growth rate. As such, if the market value of account 130 decreases, such as occurs after point 304, protected value 140 is guaranteed to never be less than the $100,000 value growing at the five percent growth rate. In certain embodiments, the growth rate utilized in these examples may alternatively be three percent, four percent, six-percent, or based on an index.

Furthermore, because protected value 140 may only be recalculated each time the market value of account 130 reaches a new high, the protected value 140 may only increase, not decrease. For example, at point 308, the market performance of account 130 peaks at a new high (e.g., it is higher than the previous high of account 130 and also higher than the previous protected value 140 growing at a five percent growth rate). As such, protected value 140 may be recalculated as that new high value (e.g., such as $150,000) growing at a five percent growth rate. Therefore, even though the market performance of account 130 decreases after point 308 and never recovers, protected value 140 is guaranteed to be that $150,000 value growing at the five percent growth rate.

In further embodiments, although protected value 140 has been described as being recalculated as the market value of account 130 each time the market value of account 130 reaches a new high, in certain embodiments, such a recalculation may only occur on a periodic basis (e.g., such as at the end of every hour, day, month, year, etc.) during a time when the market value of account 130 reaches a new high. For example, protected value 140 may only be recalculated as the market value of account 130 at the end of each day where the market performance of account 130 reached, and ended at a new high. In such an example, if the market value reaches, for example, $200,000 at 12:00 P.M., but it decreases back down to $175,000 (which is still a new high) at the end of the day, protected value 140 may only be recalculated as the $175,000 value, as opposed to the actual high of $200,000. Furthermore, if by the end of the day, the market value of account 130 decreases from the new high level, to a level that is not higher than protected value 140 (such as $140,000 when protected value is $150,000), protected value 140 may not be re-calculated at all, even though the market value of account 130 did briefly reach a new high during the day.

In further embodiments, account participant 114 may be allowed to select when protected value 140 is recalculated. For example, in a situation where the protected value 140 is only recalculated at the end of a month in which the market performance of account 130 reaches, and ends at, a new high, account participant 114 may be provided the opportunity to select the recalculation of protected value 140 at any particular time during the month. As such, if account participant 114 feels that the market value of account 130 may go down by the end of the month, account participant 114 may be allowed to cause protected value 140 to be recalculated at a time when account participant 114 feels the market value has reached a peak. In such embodiments, the number of times account participant 114 is allowed to select recalculation of protected value 140 may be determined in any suitable way, such as based on the amount of time account 130 has been activated for, the value of account 130, or any other suitable way.

FIG. 4 further illustrates the transfer of ownership of the financial instrument from an account holder (e.g., an employer) to an account participant (e.g., an employee). As is illustrated, the transfer of ownership of financial instrument 100 occurs at point 316. In one embodiment, the transfer of ownership may not affect protected value 140. For example, although the transfer of ownership occurs at the point 316, where the market performance of account 130 is below protected value 140, the protected value 140 may not be recalculated at that time. As such, despite the transfer of ownership, protected value 140 is the highest point of market performance that occurred during the period of time 312 when the employer owned the financial instrument 100, growing at a specified growth rate.

In one embodiment, after the transfer of ownership of financial instrument 100, the protected value 140 may still increase above the specified growth rate despite the fact that ownership has been transferred to the employee. For example, in one embodiment, protected value 140 may be recalculated to the market performance at point 308, which is the highest market performance that occurs during the period of time 320 where financial instrument is owned by the employee, growing at a specified growth rate.

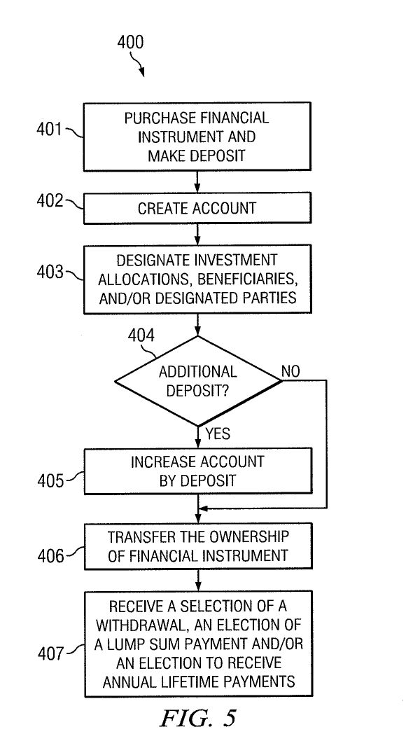

FIG. 5 provides a flowchart which illustrates the operation of a financial instrument according to a particular embodiment. Flowchart 400 traces a few of the possible scenarios that are available to customer 110 following the purchase of an embodiment of financial instrument 100. Flowchart 400 is intended to demonstrate an embodiment of financial instrument 100 in which certain features of financial instrument 100 are paid for on a daily basis through the use of a daily fee assessment, assessed on a daily basis against the value of account 130. In certain embodiments, one or more steps of flowchart 400 may be performed by or with the help of a computer, such as, for example, general purpose computer 600 described in FIG. 7.

According to flowchart 400, at step 401, account holder 112 (e.g., such as an employer) may make one or more initial deposits and purchase financial instrument 100, including lifetime payment guarantee 104 and growth rate guarantee 106, for account participant 114 (e.g., such as an employee). At step 402, account 130 is created. In one embodiment, once account 130 is created, it is owned by account holder 112. While account holder 112 owns account 130, account participant 114 may designate investment allocations for account 130, one or more beneficiaries 116, and/or one or more designated parties 118, at step 403. If additional deposits are made by account participant 112, at step 404, then the value of account 130 is increased by the amount of the additional deposits, at step 405. In some cases, a fee may be deducted from the additional deposits.

At step 406, the ownership of financial instrument 100 is transferred from account holder 112 (e.g., such an employer) to account participant 114 (e.g., such as an employee). In particular embodiments, the transfer of ownership may occur as a result of account participant 114 being terminated from employment with account holder 112, account participant 114 retiring from employment with account holder 112, or for any other suitable reason. Once financial instrument 100 is transferred to account participant 114, account holder 112 may not have any more rights in financial instrument 100. At step 407, account participant 114, beneficiaries 116, or designated party 118 may decide to make a withdrawal from account 130, receive account 130 as a lump sum payment, or decide to begin receiving annual lifetime payments from the value of financial instrument 100. In certain embodiments, the annual lifetime payments may be made from the greater of the market value of account 130 or protected value 140. As such, customer 110 receives the benefit of either the high market value or the protected value 140 insured by issuer 120.

Although not illustrated in flowchart 400, flowchart 400 further includes a calculation of protected value 140 and annual income amount (AIA). In one embodiment, protected value 140 and annual income amount may be automatically calculated whenever the market value of account 130 reaches a new high (e.g., it is higher than the previous high of account 130 and also higher than the previous protected value 140 growing at a particular growth rate, such as five percent). In a further embodiment, the protected value and annual income amount may be calculated at any other suitable time. Although also not illustrated, flowchart 400 may further include a daily update to reflect daily changes in investments 132, and an assessment of daily fees against account 130.

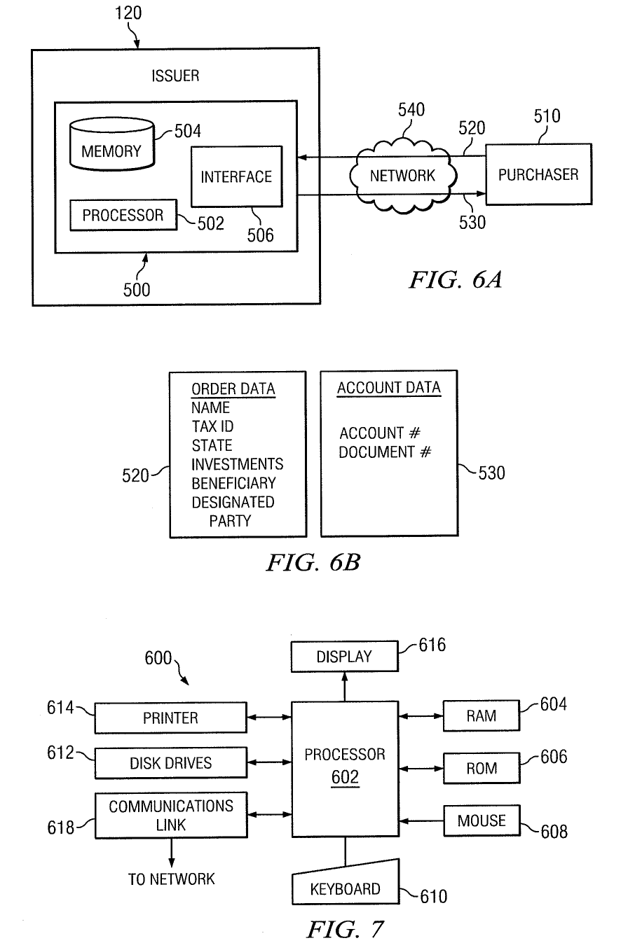

FIGS. 6A and 6B illustrate an example data processing system 500 for providing financial instrument 100 according to a particular embodiment. While in certain embodiments financial instrument 100 is entered into without using a computer, other embodiments may have a computerized option for entering into an agreement. Data processing system 500 represents hardware and controlling logic for providing financial instrument 100. In the embodiment shown, data processing system 500 may include processing module 502, memory 504, and interface 506. As shown, data processing system 500 may be included as a system controlled by issuer 120. However, in other embodiments data processing system 500 may be external to issuer 120. Additionally, although data processing system 500 is shown as a single system, data processing system 500 may be distributed across multiple platforms housed in multiple locations, some or all of which may or may not be controlled by issuer 120.

Processing module 502 may control the operation and administration of elements within data processing system 500 by processing information received from interface 506 and memory 504. Processing module 502 may include any hardware and/or controlling logic elements operable to control and process information. For example, processing module 502 may be a computer, programmable logic device, a microcontroller, and/or any other suitable device or group of devices.

Memory 504 may store, either permanently or temporarily, data and other information for processing by processing module 502 and communication using interface 506. Memory 504 may include any one or a combination of volatile or nonvolatile local or remote devices suitable for storing information. For example, memory 504 may include random access memory (RAM), read only memory (ROM), magnetic storage devices, optical storage devices, or any other suitable information storage device or combination of these devices. Memory 504 may store, among other things, order data 520 and account data 530.

Interface 506 communicates information to and receives information from devices or systems coupled to data processing system 500. For example, interface 506 may communicate with other elements controlled by issuer 120, network 540, and/or elements coupled to network 540. Thus interface 506 may include any hardware and/or controlling logic used to communicate information to and from elements coupled to data processing system 500.

Network 540 represents communication equipment, including hardware and any appropriate controlling logic, for interconnecting elements coupled to network 540. Thus network 540 may represent a local area network (LAN), a metropolitan area network (MAN), a wide area network (WAN), and/or any other appropriate form of network. Furthermore, elements within network 540 may utilize circuit-switched, packet-based communication protocols and/or other communication protocols to provide for network communications. The elements within network 540 may be connected together via a plurality of fiber-optic cables, coaxial cables, twisted-pair lines, and/or other physical media for transferring communications signals. The elements within network 540 may also be connected together through wireless transmissions, including infrared transmissions, 802.11 protocol transmissions, laser line-of-sight transmissions, or any other wireless transmission method.

In operation, order data 520 may be transmitted from purchaser 510 to data processing system 500 through network 540. Data processing system may process order data 520, generate account data 530, and transmit account data 530 to purchaser 510 through network 540. Purchaser 510 may represent one or more customers 110 or purchaser 510 may represent one or more intermediaries acting on behalf of customers 110.

Order data 520 may include the name of account holder 112, one or more tax identifiers, the resident state of account holder 112, an initial investment allocation designation, and a designation of beneficiary 116 and/or designated party 118. Account data 530 may include an account number and a document, or reference to a document, containing the provisions of financial instrument 100.

Upon receipt of order data 520, data processing system 500 may calculate any applicable fees associated with the provisions of financial instrument 100. Data processing system may also identify account 130 and identify assets and fees associated with account 130.

In certain embodiments, purchaser 510 may initiate the transmission of order data 520 through the use of a web-based application. For example, purchaser 510 may access one or more websites and may submit certain portions of order data using those websites. Similarly, purchaser 510 may utilize one or more electronic fund transfer (EFT) technologies to purchase financial instrument 100. The use of internet technologies to purchase financial instrument 100 may involve the use of one or more security provisions such as digital signatures, digital certificates, passwords, and encryptions. In certain embodiments, the collection of order data 520 may occur through the use of an interactive process. For example, a web-based application may present a series of questions to purchaser 510, which purchaser 510 may respond to and, in responding, submit the contents of order data 520.

FIG. 7 is an embodiment of a general purpose computer 600 that may be used in connection with one or more pieces of software used to implement the invention. General purpose computer 600 may generally be adapted to execute any of the well-known OS2, UNIX, Mac-OS, Linux, and Windows Operating Systems or other operating systems. The general purpose computer 600 in this embodiment comprises a processor 602, a random access memory (RAM) 604, a read only memory (ROM) 606, a mouse 608, a keyboard 610 and input/output devices such as a printer 614, disk drives 612, a display 616 and a communications link 618. In other embodiments, the general purpose computer 600 may include more, less, or other component parts. Embodiments of the present invention may include programs that may be stored in the RAM 604, the ROM 606 or the disk drives 612 and may be executed by the processor 602. The communications link 618 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding. Disk drives 612 may include a variety of types of storage media such as, for example, floppy disk drives, hard disk drives, CD ROM drives, DVD ROM drives, magnetic tape drives or other suitable storage media.

Although FIG. 7 provides one embodiment of a computer that may be used with the invention, the invention may additionally utilize computers other than general purpose computers as well as general purpose computers without conventional operating systems. Additionally, embodiments of the invention may also employ multiple general purpose computers 600 or other computers networked together in a computer network. Most commonly, multiple general purpose computers 600 or other computers may be networked through the Internet and/or in a client server network. Embodiments of the invention may also be used with a combination of separate computer networks each linked together by a private or a public network.

Several embodiments may include logic contained within a medium. In the embodiment of FIG. 7, the logic comprises computer software executable on the general purpose computer 600. The medium may include the RAM 604, the ROM 606 or the disk drives 612. In other embodiments, the logic may be contained within hardware configuration or a combination of software and hardware configurations. The logic may also be embedded within any other suitable medium without departing from the scope of the invention.

Although the present invention has been described in several embodiments, a myriad of changes and modifications may be suggested to one skilled in the art, and it is intended that the present invention encompass such changes and modifications as fall within the present appended claims.

To aid the Patent Office, and any readers of any patent issued on this application in interpreting the claims appended hereto, applicants wish to note that they do not intend any of the appended claims to invoke ¶ 6 of 35 U.S.C. §112 as this paragraph and section exists on the date of filing hereof unless “means for” or “step for” are used in the particular claim.

What is claimed is:

1. A method for administering a financial instrument, the method comprising:
storing a balance of an employee retirement plan account created for an employee and owned by an employer of the employee, the employee retirement plan account comprising one or more variable investments, the balance of the employee retirement plan account being based, at least in part, on an initial deposit into the employee retirement plan account from a deduction from wages paid by the employer to the employee;
storing a minimum positive growth rate;
updating the stored balance of the employee retirement plan account based on market performance of the one or more variable investments;
calculating, by one or more processor devices executing logic, a protected value, the calculated protected value being at least equal to the initial deposit into the employee retirement plan account growing at the stored minimum positive growth rate, wherein the calculated protected value represents a guaranteed positive rate of return regardless of market performance of the one or more investments; and
upon occurrence of one or more events, transferring ownership of the employee retirement plan account from the employer to the employee, wherein subsequent to or simultaneous to the transfer of ownership, a beneficiary designated by the employee is guaranteed to receive the beneficiary's choice of either:
a lump sum of money from the employee retirement plan account based on the updated stored balance of the employee retirement plan account, or
for the life of the employee or the beneficiary, periodic payments of an amount of money from the employee retirement plan account based on the calculated protected value regardless of the market performance of the one or more investments.

2. The method of claim 1, wherein the employer comprises a corporation or a corporate sponsored trust.

3. The method of claim 2, wherein the employee retirement plan account comprises a variable annuity.

4. The method of claim 1, further comprising:
receiving, during a time when the employer owns the employee retirement plan account, a selection of the one or more variable investments from the employee; and
storing, in the employee retirement plan account, the one or more variable investments selected by the employee.

5. The method of claim 4, further comprising, in response to a determination that the market performance of the one or more variable investments selected by the employee has caused the updated stored balance of the employee retirement plan account to decrease below a threshold:
removing, from the employee retirement plan account, at least one of the one or more variable investments selected by the employee;
storing, in the employee retirement plan account, one or more supplemental variable investments selected by a different entity; and
further updating the updated stored balance of the employee retirement plan account based on market performance of the remaining one or more variable investments selected by the employee and market performance of the one or more supplemental variable investments selected by the different entity.

6. The method of claim 1, wherein the one or more events includes retirement of the employee from working for the employer or termination of the employee from working for the employer.

7. The method of claim 1, wherein the deduction from the wages paid by the employer to the employee comprises a pre-tax deduction from the wages paid by the employer to the employee.

8. The method of claim 1, further comprising, in response to a determination that the market performance of the one or more variable investments has caused the updated stored balance of the employee retirement plan account to increase above the calculated protected value, updating the calculated protected value to be at least the updated stored balance of the employee retirement plan account growing at the stored minimum positive growth rate.

9. A data processing system, comprising:
one or more processing modules; and
one or more memory devices storing:
a balance of an employee retirement plan account created for an employee and owned by an employer of the employee, the employee retirement plan account comprising one or more variable investments, the balance of the employee retirement plan account being based, at least in part, on an initial deposit into the employee retirement plan account from a deduction from wages paid by the employer to the employee;
a minimum positive growth rate; and
software configured, when executed by the one or more processing modules, to:
update the stored balance of the employee retirement plan account based on market performance of the one or more variable investments;
calculate a protected value, the calculated protected value being at least equal to the initial deposit into the employee retirement plan account growing at the stored minimum positive growth rate, wherein the calculated protected value represents a guaranteed positive rate of return regardless of market performance of the one or more investments; and
upon occurrence of one or more events, transfer ownership of the employee retirement plan account from the employer to the employee, wherein subsequent to or simultaneous to the transfer of ownership, a beneficiary designated by the employee is guaranteed to receive the beneficiary's choice of either:
a lump sum of money from the employee retirement plan account based on the updated stored balance of the employee retirement plan account, or
for the life of the employee or the beneficiary, periodic payments of an amount of money from the employee retirement plan account based on the calculated protected value regardless of the market performance of the one or more investments.

10. The system of claim 9, wherein the employer comprises a corporation or a corporate sponsored trust.

11. The system of claim 10, wherein the employee retirement plan account comprises a variable annuity.

12. The system of claim 9, wherein the software is further configured, when executed by the one or more processing modules, to:
receive, during a time when the employer owns the employee retirement plan account, a selection of the one or more variable investments from the employee; and
store, in the employee retirement plan account, the one or more variable investments selected by the employee.

13. The method of claim 12, wherein in response to a determination that the market performance of the one or more variable investments selected by the employee has caused the updated stored balance of the employee retirement plan account to decrease below a threshold, the software is further configured, when executed by the one or more processing modules, to:
remove, from the employee retirement plan account, at least one of the one or more variable investments selected by the employee;
store, in the employee retirement plan account, one or more supplemental variable investments selected by a different entity; and
further update the updated stored balance of the employee retirement plan account based on market performance of the remaining one or more variable investments selected by the employee and market performance of the one or more supplemental variable investments selected by the different entity.

14. The system of claim 9, wherein the one or more events includes retirement of the employee from working for the employer or termination of the employee from working for the employer.

15. The system of claim 9, wherein the deduction from the wages paid by the employer to the employee comprises a pre-tax deduction from the wages paid by the employer to the employee.

16. The system of claim 9, wherein in response to a determination that the market performance of the one or more variable investments has caused the updated stored balance of the employee retirement plan account to increase above the calculated protected value, the software is further configured, when executed by the one or more processing modules, to update the calculated protected value to be at least the updated stored balance of the employee retirement plan account growing at the stored minimum positive growth rate.

17. A tangible medium encoded with software, the software configured, when executed by one or more processing modules, to:
store a balance of an employee retirement plan account created for an employee and owned by an employer of the employee, the employee retirement plan account comprising one or more variable investments, the balance of the employee retirement plan account being based, at least in part, on an initial deposit into the employee retirement plan account from a deduction from wages paid by the employer to the employee;
store a minimum positive growth rate;
update the stored balance of the employee retirement plan account based on market performance of the one or more variable investments;
calculate a protected value, the calculated protected value being at least equal to the initial deposit into the employee retirement plan account growing at the stored minimum positive growth rate, wherein the calculated protected value represents a guaranteed positive rate of return regardless of market performance of the one or more investments; and
upon occurrence of one or more events, transfer ownership of the employee retirement plan account from the employer to the employee, wherein subsequent to or simultaneous to the transfer of ownership, a beneficiary designated by the employee is guaranteed to receive the beneficiary's choice of either:
a lump sum of money from the employee retirement plan account based on the updated stored balance of the employee retirement plan account, or
for the life of the employee or the beneficiary, periodic payments of an amount of money from the employee retirement plan account based on the calculated protected value regardless of the market performance of the one or more investments.

18. The tangible medium of claim 17, wherein the employer comprises a corporation or a corporate sponsored trust.

19. The tangible medium of claim 18, wherein the employee retirement plan account comprises a variable annuity.

20. The tangible medium of claim 17, wherein the software is further configured, when executed by one or more processing modules, to:
receive, during a time when the employer owns the employee retirement plan account, a selection of the one or more variable investments from the employee; and
store, in the employee retirement plan account, the one or more variable investments selected by the employee.

21. The tangible medium of claim 20, wherein in response to a determination that the market performance of the one or more variable investments selected by the employee has caused the updated stored balance of the employee retirement plan account to decrease below a threshold, the software is further configured, when executed by one or more processing modules, to:
remove, from the employee retirement plan account, at least one of the one or more variable investments selected by the employee;
store, in the employee retirement plan account, one or more supplemental variable investments selected by a different entity; and
further update the updated stored balance of the employee retirement plan account based on market performance of the remaining one or more variable investments selected by the employee and market performance of the one or more supplemental variable investments selected by the different entity.

22. The tangible medium of claim 17, wherein the one or more events includes retirement of the employee from working for the employer or termination of the employee from working for the employer.

23. The tangible medium of claim 17, wherein the deduction from the wages paid by the employer to the employee comprises a pre-tax deduction from the wages paid by the employer to the employee.

24. The tangible medium of claim 17, wherein in response to a determination that the market performance of the one or more variable investments has caused the updated stored balance of the employee retirement plan account to increase above the calculated protected value, the software is further configured, when executed by one or more processing modules, to update the calculated protected value to be at least the updated stored balance of the employee retirement plan account growing at the stored minimum positive growth rate.
